(19) United States
(12) Patent Application Publication
(10) Pub. No.: US 2025/0081290 A1
(43) Pub. Date: Mar. 6, 2025

(54) MANAGING PAGING FOR MULTICAST AND BROADCAST SERVICES

(71) Applicant: GOOGLE LLC, Mountain View, CA (US)

(72) Inventor: Chih-Hsiang Wu, Taoyuan City (TW)

(21) Appl. No.: 18/293,949

(22) PCT Filed: Aug. 4, 2022
(86) PCT No.: PCT/US2022/039398

§ 371 Date: Jan. 31, 2024

Related U.S. Application Data
(60) Provisional application No. 63/203,991, filed on Aug. 5, 2021.

(51) Int. Cl. H04W 76/40; H04W 68/02

(52) U.S. Cl. CPC H04W 76/40; H04W 68/02

(57) ABSTRACT

A central node (CN) and a radio access network (RAN) can implement a method for managing paging for multicast and broadcast services (MBS). The method includes: receiving, from an MBS network, an identifier for an MBS session; transmitting, to a RAN, a message including the identifier for the MBS session; transmitting, to the RAN, one or more parameters associated with the MBS session; and transmitting, to the RAN, one or more MBS data packets to be broadcast to a user equipment (UE) in accordance with the one or more parameters.

### FIELD OF THE DISCLOSURE

This disclosure relates to wireless communications and, more particularly, to paging UEs for one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

UEs communicating with base stations operating according to 5G, 6G, or later-generation requirements may support a 100 MHz bandwidth in a frequency range 1 (FR1) and a 400 MHz bandwidth in a frequency range 2 (FR2). Due to the relatively wide bandwidth of a typical carrier, such a base station can provide multicast and/or broadcast services (MBS) to UEs used in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure one or more UEs with a common frequency resource (CFR) and a physical downlink control channel (PDCCH) configuration configuring a group common PDCCH. The base station can assign a group common radio network temporary identifier (RNTI) to the UEs to receive physical downlink shared channel (PDSCH) transmissions including the MBS data packet(s). Then the base station can send downlink control information (DCI) to the UEs to schedule a PDSCH transmission including MBS data packet(s).

### SUMMARY

A network node provides and manages MBS for one or more UEs in an inactive or idle state. To initiate an MBS session with the one or more UEs, a RAN node transmits an identifier for the MBS session through one or more paging messages, causing the UEs the initiate MBS communication. The RAN node then broadcasts MBS data packets to the UEs in accordance with resource configurations.

Further, the CN facilitates communication between the RAN node and the MBS network, providing the identifier for the MBS session and parameters for paging or resource configurations for the MBS session to the RAN node. The CN in some cases can also provide one or more paging configurations to the RAN node for use in paging and/or communicating with the UEs.

One example embodiment of these techniques is a method for managing paging for MBS, implemented in a CN. The method includes receiving, by processing hardware and from an MBS network, an identifier for an MBS session; transmitting, by the processing hardware to a radio access network (RAN), a message including the identifier for the MBS session; transmitting, by the processing hardware to the RAN, one or more parameters associated with the MBS session; and transmitting, by the processing hardware to the RAN, one or more MBS data packets to be broadcast to a user equipment (UE) in accordance with the one or more parameters.

Another example embodiment of these techniques is a method for managing paging for MBS, implemented in a RAN. The method includes receiving, by processing hardware and from a core network (CN), an identifier for an MBS session and an indication to configure resources for the MBS session; transmitting, by the processing hardware to a user equipment (UE), a paging message including the identifier for the MBS session, when one or more radio connections between the UE and the RAN are inactive; and subsequently to the transmitting, broadcasting, by the processing hardware to the UE in accordance with one or more MBS resource configurations, one or more MBS data packets.

### BRIEF DESCRIPTION OF THE DRAWINGS

FIG. 1A is a block diagram of an example system in which a base station and/or a user equipment (UE) can implement the techniques of this disclosure for managing multicast and broadcast services (MBS) in a UE;

FIG. 1B is a block diagram of an example base station including a central unit (CU) and a distributed unit (DU) that can operate in the system of FIG. 1A;

FIG. 2 is a block diagram of an example protocol stack according to which the UE of FIGS. 1A-B can communicate with base stations;

FIG. 3 illustrates an example scenario in which a RAN pages an identifier to a UE in an inactive or idle state to begin MBS reception before broadcasting MBS data to the UE;

FIG. 4A illustrates a scenario similar to that of FIG. 3, but in which the RAN pages an identifier to a UE in an idle state to begin MBS reception before performing a radio connection establishment procedure;

FIG. 4B illustrates a scenario similar to that of FIG. 4A, but in which the RAN pages a UE in an inactive state to begin MBS reception before performing a radio resume procedure;

FIG. 5A illustrates an example scenario in which a RAN receives a message from the CN for paging each UE to begin MBS reception, each message including an MBS session identifier and a UE identifier for the particular UE;

FIG. 5B illustrates a scenario similar to that of FIG. 5A, but in which the RAN receives a single message from the CN including the MBS session identifier and an identifier for each UE to join the MBS session;

FIG. 6A is a flow diagram of an example method for generating and transmitting a number of messages to the RAN, each message including the MBS session identifier, an identifier for a UE of the number of UEs, and a paging cycle configuration for the UE, implemented in a CN;

FIG. 6B is a flow diagram of an example method similar to that of FIG. 6A, but in which the CN generates and transmits a single message including each UE identifier and each paging cycle configuration, implemented in a base station;

FIG. 6C is a flow diagram of an example method similar to that of FIG. 6A, but in which the CN generates and transmits a single message including a single paging cycle configuration, implemented in a base station;

FIG. 7 is a flow diagram of an example method for determining whether to generate and transmit a message including an MBS session identifier or a message including a UE identifier based on whether a service is an MBS, implemented in a CN;

FIG. 8 is a flow diagram of an example method for determining whether to transmit a message including an MBS session identifier or including a UE identifier based on whether the CN is transmitting the message for an MBS session, implemented in a CN;

FIG. 9 is a flow diagram of an example method for determining whether to include an MBS session identifier in a message based on whether the CN instructs the RAN to page the UE for an MBS, implemented in a CN;

FIG. 10A is a flow diagram of an example method for generating and transmitting a message to the RAN including an MBS session identifier for each of one or more MBS sessions without including UE identifiers, implemented in a CN;

FIG. 10B is a flow diagram of an example method similar to FIG. 10A, but in which the CN includes UE identifiers in the message, implemented in a CN;

FIG. 11 is a flow diagram of an example method for determining whether to include an MBS session identifier or a UE identifier in a UE identifier field of a paging message to the RAN, implemented in a CN;

FIG. 12 is a flow diagram of an example method for determining whether to include an MBS session identifier and an indication to the RAN to page multiple UEs or a UE identifier in a paging message to the RAN based on whether the CN determines to send the paging message for an MBS session, implemented in a CN;

FIG. 13 is a flow diagram of an example method for determining whether to generate and transmit a message including the MBS session identifier or multiple UE identifiers based on whether a base station of a RAN supports paging for MBS, implemented in a CN;

FIG. 14A is a flow diagram of an example method for receiving a message from the CN and generating and transmitting a paging message to multiple UEs over multiple paging cycles, implemented in a RAN;

FIG. 14B is a flow diagram of an example method similar to FIG. 14A, but in which the RAN generates a number of paging messages that the RAN transmits to the UEs in multiple paging cycles, implemented in a RAN;

FIG. 15 is a flow diagram of an example method for managing paging for multicast and broadcast services, implemented in a RAN; and

FIG. 16 is a flow diagram of an example method for managing paging for multicast and broadcast services, implemented in a CN.

### DETAILED DESCRIPTION OF THE DRAWINGS

Generally speaking, the techniques of this disclosure allow UEs to receive MBS information via radio resources allocated by a base station of a RAN. To this end, the base station can configure different radio resources in one or multiple overlapping cells to multicast or broadcast MBS data (and associated control information) and/or unicast non-MBS data (and associated control information) with one or multiple UEs on the downlink (DL). Note that “transmit” by a base station may interchangeably refer to “multicast”. “broadcast”, and/or “unicast.” The base station can also unicast MBS data (and associated control information) to a UE on a dedicated DRB for the UE. The one or more multiple UEs can transmit non-MBS data to the base station on the uplink (UL).

Accordingly, a base station of this disclosure can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

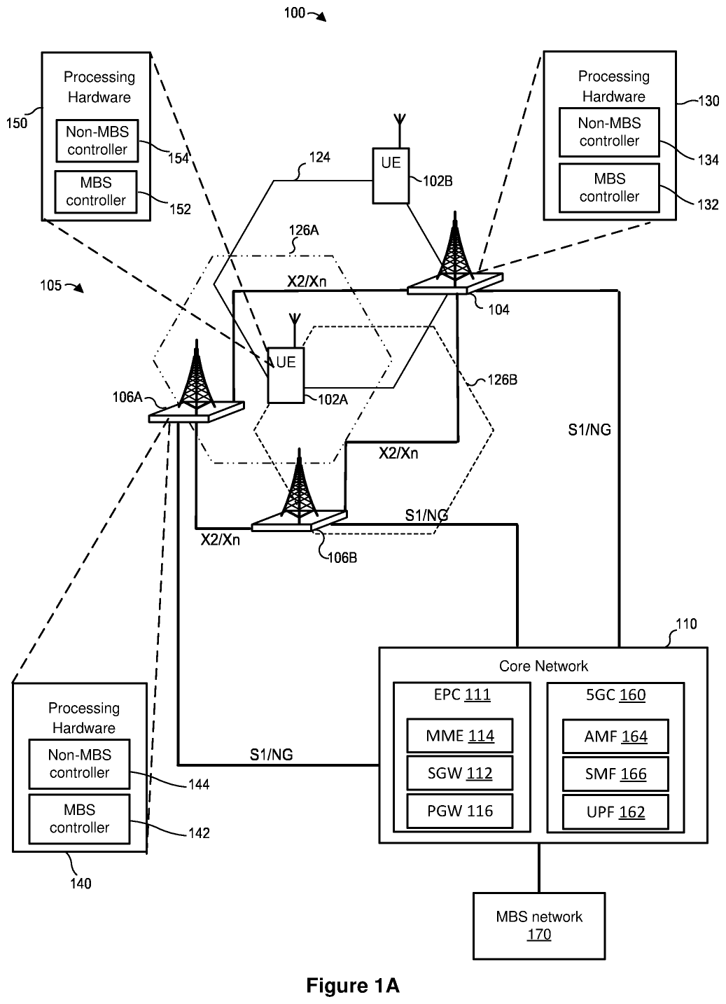

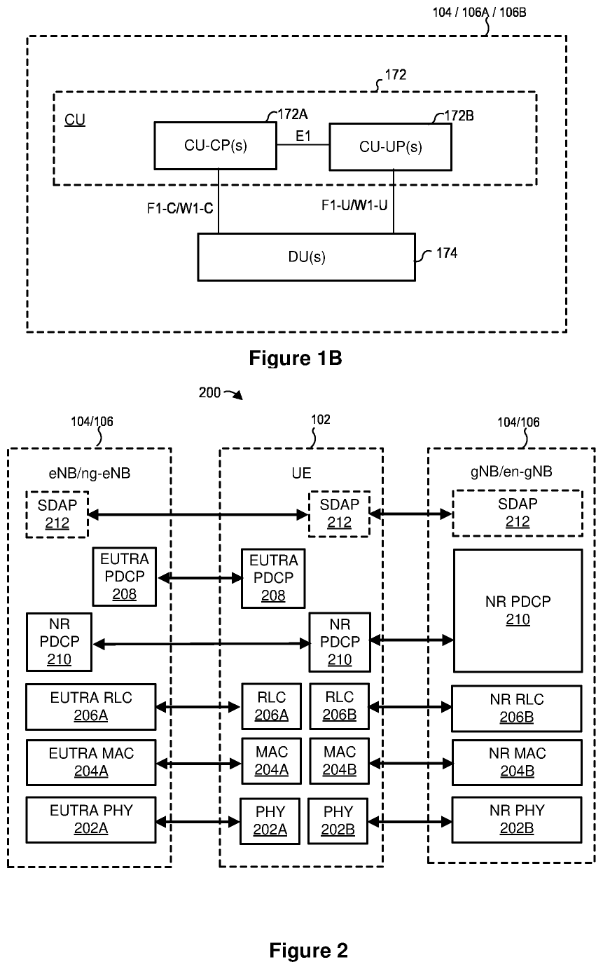

FIG. 1A depicts an example wireless communication system 100 that can implement MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To case readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation cNB (ng-eNB), a 5G Node B (gNB) or a 6G base station, for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-cNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations (e.g., MBS activation notification), as discussed below. The processing hardware 130 can include a base station non-MBS controller 134 configured to manage or control one or more RRC configurations and/or RRC procedures when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations (e.g., MBS activation notification), as discussed below. The processing hardware 140 can include a base station non-MBS controller 144 configured to manage or control one or more RRC configurations and/or RRC procedures when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations (e.g., MBS activation notification), as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-cNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-cNB 106A.

With continued reference to FIG. 1A, the CN 110 communicatively connects the UE 102, to an MBS network 170, via the RAN 105. The MBS network 170 can provide to the UE 102 multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety. To this end, an entity (e.g., a server or a group of servers) operating in the MBS network 170 supports packet exchange with the UE. The packets can convey signaling (such as session initiation protocol (SIP) messages, IP messages, or other suitable messages) as well as data (“or media”) such as text messages, audio and/or video.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

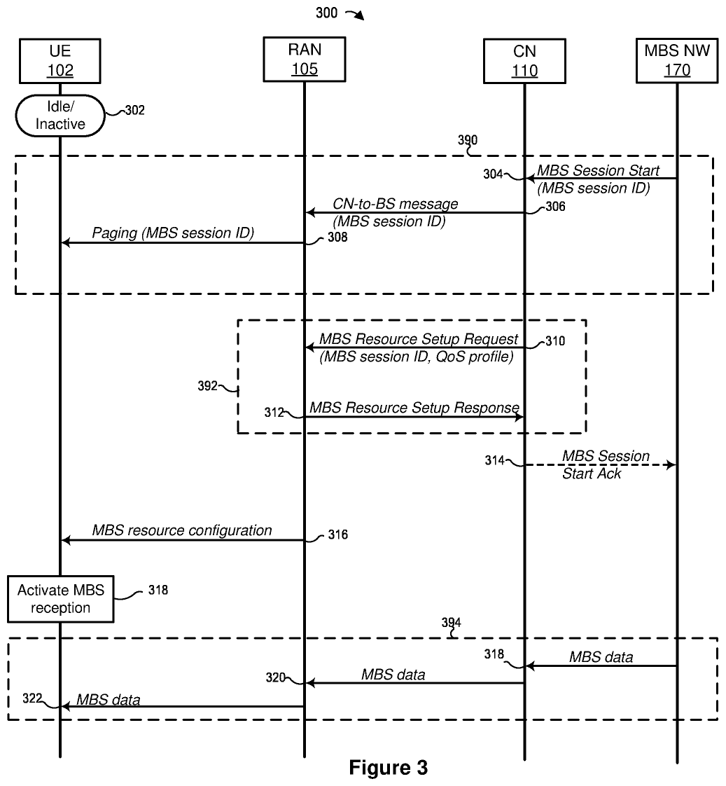

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

To simplify the following description, the UE 102 represents the UE 102A and the UE 102B, unless explicitly described.

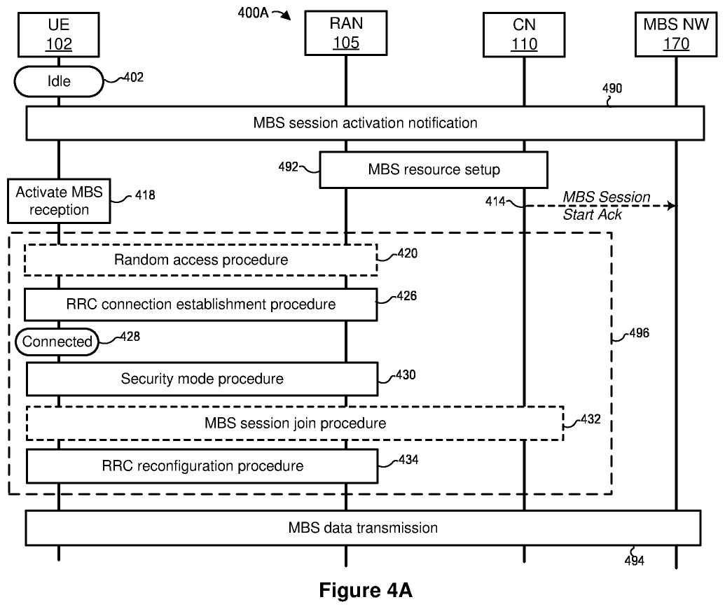

FIGS. 3-5B are messaging diagrams of example scenarios in which one or more UEs, the RAN, the CN and the MBS network implement the techniques of this disclosure for managing MBS transmission and reception. Generally speaking, events in FIGS. 3-5B that are similar are labeled with similar reference numbers, with differences discussed below where appropriate. With the exception of the differences shown in the figures and discussed below, any on the alternative implementations discussed with respect to a particular event (e.g., for messaging and processing) may apply to events labeled with similar reference numbers in other figures.

Now referring to a scenario 300 illustrated in FIG. 3, UE 102 (e.g., the UE 102A and/or UE 102B) initially operates 302 in an idle state (e.g., RRC_IDLE state) or an inactive state (e.g., RRC_INACTIVE state) with RAN 105. In the following description, the RAN 105 can represent base station 104, base station 106, cell 124 of the base station 104 and/or cell 126 of the base station 106). For example, the UE 102 operating in the idle state or the inactive state camps on a cell 124 of base station 104 of the RAN 105. MBS network 170 sends 304 an MBS Session Start message (or called MBS Session Start Request message) to CN 110 (e.g., AMF 164) to requests activation of an MBS session. The MBS network 170 includes an MBS session ID to identifying the MBS session in the MBS Session Start message. In some implementations, the MBS session ID is allocated by the CN 110. In other implementations, the MBS session ID is allocated by the MBS network 170. In some implementations, the MBS session ID can be or include a Temporary Mobile Group Identity (TMGI). In other implementations, the MBS session ID can be associated with a TMGI.

In response to the MBS Session Start message, the CN 110 can notify UEs of activation of the MBS session. To notify UEs of the MBS session activation, the CN 110 generates a CN-to-BS message including the MBS session ID and sends 306 the CN-to-BS message to the RAN 105. In some implementations, the CN-to-BS message can be an existing or new next generation application protocol (NGAP) message defined in 3GPP specification 38.413. For example, the existing NGAP message can be a NGAP Paging message. In other implementations, the CN-to-BS message can be a 6G application protocol (6GAP) Paging message.

Upon receiving 306 the CN-to-BS message, the RAN 105 extracts the MBS session ID from the CN-to-BS message and generates a paging message including the MBS session ID. Then the RAN 105 transmits 308 (i.e., via broadcast) the paging message on one or more radio resources, e.g., on the cell 124. The RAN 105 can transmit the paging message on a paging control channel (PCCH). In some implementations, the RAN 105 can generate a DCI and a CRC of the DCI from the DCI to transmit the paging message. The RAN 105 scrambles the CRC with a paging radio network temporary identifier (P-RNTI). The RAN 105 can include a downlink assignment in the DCI, which indicates a radio resource for a transmission of the paging message. The RAN 105 can transmit the DCI and the scrambled CRC on a PDCCH to the UE 102 and the transmit the paging message on the indicated radio resource. When the UE 102 (i.e., the UE 102A and UE 102B) receives the DCI and the scrambled CRC on the PDCCH, the UE 102 verifies the scrambled CRC with the P-RNTI. If the UE 102 verifies the scrambled CRC is valid, the UE 102 receives or attempts to receive 308 the paging message on the radio resource in accordance with the DCI. After or in response to receiving 308 the paging message, the UE 102 in the idle state or the inactive state activates (e.g., initiates) 318 reception of the MBS session identified by the MBS session ID.

In some implementations, the RAN 105 transmits the DCI and scrambled CRC in a paging occasion where the UE 102A and UE 102B can receive. In some scenarios and implementations, other UE(s) can receive the DCI and scrambled CRC in the paging occasion. In some implementations, the paging occasion is within a group paging DRX cycle (or called MBS (paging) DRX cycle). The RAN 105 can transmit (e.g., via broadcast) a group paging DRX cycle configuration (or called MBS paging DRX cycle configuration) configuring the group paging DRX cycle, e.g., on the cell 124. In some implementations, the RAN 105 can broadcast system information including the group paging DRX cycle configuration on a BCCH. Alternatively, the RAN 105 can broadcast a message including the group paging DRX cycle configuration on a MCCH. Thus, the UE 102A and UE 102B can receive the group paging DRX cycle configuration from the system information or the message on the MCCH. In other implementations, the UE 102A, UE 102B and RAN 105 can receive the group paging DRX cycle configuration form the CN 110. For example, the UE 102A and UE 102B can perform a NAS procedure with the CN 110 to receive the group paging DRX cycle configuration, respectively. For example, the NAS procedure can be a Registration procedure. In another example, the NAS procedure can be an MBS session join procedure, an MBS session activation procedure or an MBS-related procedure. The CN 110 can send the group paging DRX cycle configuration in the CN-to-BS message that the CN 110 transmits 306.

In other implementations, the paging occasion is within a first paging DRX cycle of the UE 102A and a second paging DRX cycle of the UE 102B. In such cases, the first and second paging DRX cycles are partially or completely overlapped. In cases where the other UE(s) can receive the DCI and scrambled CRC on the paging occasion, the paging occasion is within third paging DRX cycle(s) of the other UE(s). In such cases, the first, second and third paging DRX cycles are partially or completely overlapped. In some implementations, the UE 102A, UE 102B and other UE(s) can derive or determine the first paging DRX cycle, second paging DRX cycle, third paging DRX cycle(s) respectively in accordance with section 7.1 in 3GPP specification 38.304. In some implementations, the RAN 105 can receive the first, second and/or third paging DRX cycle configurations from the CN 110, e.g., in the CN-to-BS message or in another CN-to-BS message.

In some implementations, the RAN 105 can transmit additional DCI(s) and scrambled CRC(s) of the additional DCI(s) in additional paging occasion(s), each scheduling a transmission of the paging message in order to ensure that the UE 102A, UE 102B and/or other UE(s) can receive the paging message, similar to transmitting the DCI and scrambled CRC as described above.

In some implementations, the RAN 105 can transmit the DCIs and scrambled CRCs in multiple PDCCH occasions (or called PDCCH monitoring occasions) irrespective of a paging DRX cycle. The RAN 105 can transmit (e.g., via broadcast) system information to configure the multiple PDCCH occasions to the UE 102A, UE 102B and/or other UE(s). For example, the system information can include a search space configuration (e.g., pagingSearchSpace) and/or PDCCH monitoring configuration(s) (e.g., firstPDCCH-MonitoringOccasionOfPO and nrofPDCCH-MonitoringOccasionPerSSB-InPO). Each of the UE 102A, UE 102B and/or other UE(s) monitor a particular portion of the multiple PDCCH occasions in accordance with the multiple PDCCH occasions. Each of the UE 102A, UE 102B and/or other UE(s) monitor a particular portion of the multiple PDCCH occasions in accordance with the multiple PDCCH occasions. For example, the UE 102A can monitor a first portion of the multiple PDCCH occasions in accordance with the first paging DRX cycle configuration, the UE 102B can monitor a second portion of the multiple PDCCH occasions in accordance with the second paging DRX cycle configuration and/or the other UE(s) can monitor a third portion of the multiple PDCCH occasions in accordance with the third paging DRX cycle configuration(s).

Events 304, 306 and 308 collectively define an MBS session activation notification procedure 390.

After receiving 304 the MBS Session Start message, the CN 110 can send 310 to the RAN 105 an MBS Resource Setup Request message (e.g., MBS Session Resource Setup Request message) including the MBS session ID, to request the RAN 105 to assign resources on an air interface (e.g., Uu) and resources on a network interface (e.g., NG-U) between the RAN 105 and the CN 110 for an MBS session identified by the MBS session ID. In some implementations, the CN 110 can include in the MBS Resource Setup Request message a quality of service (QOS) profile to indicate QoS parameters associated with the MBS session. In some implementations, the CN 110 sends the MBS Resource Setup Request message in response to receiving the MBS Session Start message. In one implementation, the CN 110 sends the MBS Resource Setup Request message after transmitting 306 the CN-to-BS message. In another implementation, the CN 110 sends the MBS Resource Setup Request message before transmitting 306 the CN-to-BS message.

In response to the MBS Session Resource Setup message, the RAN 105 can assign radio resources for transmitting (e.g., broadcasting or multicasting) data of the MBS session and transmit 312 an MBS Resource Setup Response message (e.g., MBS Session Resource Setup Response message) to the CN 110. The radio resources include time resources (e.g., time slots or OFDM symbols) and/or frequency resources (e.g., resource blocks) for one or more control channels and/or one or more data channels. The RAN 105 can broadcast 316 MBS resource configuration(s) to indicate or configure the radio resources, e.g., on the cell 124. The RAN 105 can transmit one or more PDSCH transmissions including MBS data packet(s) in accordance with the MBS resource configuration(s). For example, the MBS resource configuration(s) include a PDCCH configuration, a search space configuration and/or a control resource set (CORESET) configuration. The RAN 105 can send downlink control information (DCI(s)), each with a cyclic redundancy check (CRC) scrambled by an RNTI (e.g., a group RNTI or an MBS RNTI), on a PDCCH to schedule a PDSCH transmission including MBS data packet(s) in accordance with the PDCCH configuration, search space configuration, and/or CORESET configuration. In another example, the MBS resource configuration(s) can include a modulation and coding scheme (MCS), repetitions, and/or hybrid automatic repeat request (HARQ) transmission scheme for broadcasting data from the MBS session. The RAN 105 can transmit a PDSCH transmission including MBS data packet(s) in accordance with the configured MBS, repetitions, and/or HARQ transmission scheme. In some implementations, the RAN 105 can broadcast 316 system information including the MBS resource configuration(s) on a broadcast control channel (BCCH), e.g., on the cell 124. In other implementations, the RAN 105 can broadcast 316 MBS resource configuration(s) on a multicast control channel (MCCH), e.g., on the cell 124. In some implementations. The RAN 105 can periodically broadcast the MBS resource configuration(s). In some implementations, the RAN 105 can broadcast the MBS resource configuration(s) before or after transmitting 308 the paging message.

Events 310 and 312 collectively define an MBS resource setup procedure 392.

The CN 110 can send 314 an MBS Session Start Acknowledge message to the MBS network 170 in response to the MBS Session Start message. In some implementations, the CN 110 sends the MBS Session Start Acknowledge message after receiving the MBS Resource Setup Response message. In other implementations, the CN 110 sends the MBS Session Acknowledge message to the MBS network irrespective of receiving the MBS Resource Setup Response message.

After transmitting 304 the MBS Session Start message or receiving 314 the MBS Session Start Acknowledge message, the MBS network 170 can transmit 318 MBS data (e.g., one or more MBS data packets) of the MBS session to the CN 110, which in turn transmits 320 the MBS data to the RAN 105. The RAN 105 then broadcasts 322 the MBS data using the MBS resource configuration(s), e.g., on the cell 124, as described above.

After or in response to receiving 308 the paging message, the UE 102 in the idle state or the inactive state activates (e.g., initiates) 318 reception of the MBS session identified by the MBS session ID. The UE 102 receives 322 the MBS data in accordance with the MBS resource configuration(s). For example, the UE 102 receives 322 one or more PDSCH transmissions including the MBS data on the radio resources configured by the MBS configuration(s) and decode the PDSCH transmission(s) in accordance with the MCS to obtain the MBS data. In another example, the UE 102 receives 332 the DCI(s) scheduling PDSCH transmission(s) including the MBS data in accordance with the MBS resource configuration(s) and decode the PDSCH transmission(s) in accordance with the DCI(s) to obtain the MBS data.

Events 318, 320 and 322 collectively define an MBS data transmission procedure 394.

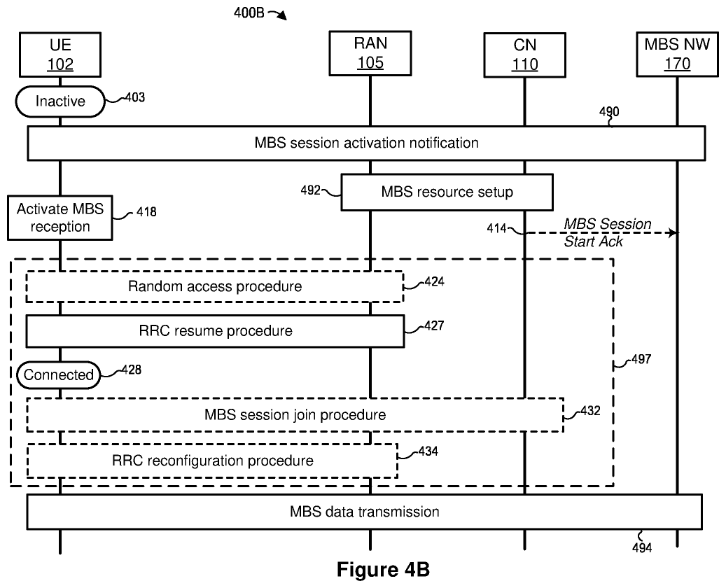

FIG. 4A and FIG. 4B are example message sequences similar to the message sequences of FIG. 3, but where the UE 102 transitions to a connected state from the inactive state and the idle state, respectively.

Turning first to FIG. 4A, in a scenario 400A, the UE 102 initially operates 402 in the idle state. The UE 102 in the idle state receives an MBS activation notification message (i.e., the MCCH message or the paging message) in the MBS session activation notification procedure 490, similar to the MBS session activation notification procedure 390. In some implementations, the MBS session ID in FIG. 4A identifies a multicast session, and the MBS session ID in FIG. 3 identifies a broadcast session.

In response to the activation 418, the UE 102 performs 426 an RRC connection establishment procedure with the RAN 105. The UE 102 transitions 428 to a connected state (e.g., RRC_CONNECTED state) in response to the RRC connection establishment procedure. To perform 426 the RRC connection establishment procedure, the UE 102 can perform 424 a random access procedure with the RAN 105 to synchronize with the RAN 105 in uplink transmission, such as in cases where the UE 102 is not uplink synchronized with the RAN 105 (i.e., the UE 102 does not have a valid timing advance command or value with the RAN 105). Depending on the implementation, the random access procedure is a two-step or four-step random access procedure. To perform 426 the RRC connection establishment procedure, the UE 102 transmits an RRC request message (e.g., RRCSetupRequest message or RRCConnectionRequest message) to the RAN 105. In cases where the UE 102 performs 424 a two-step random access procedure, the UE 102 can transmit the RRC request message in a message (e.g., message A) of the two-step random access procedure. In cases where the UE 102 performs 424 a four-step random access procedure, the UE 102 can transmit the RRC request message in a message (e.g., message 3) of the four-step random access procedure. In cases where the UE 102 is uplink synchronized with the RAN 105 and has a configured grant configuration for the idle state, the UE 102 can skip or omit the random access procedure. In such cases, the UE 102 can transmit the RRC Request message using a configured grant that is configured by the configured grant configuration.

In response to the RRC request message, the RAN 105 can transmit an RRC response message (e.g., RRCSetup message or RRCConnectionSetup message) to the UE 102. In response, the UE 102 transitions 428 to the connected state and transmits an RRC complete message (e.g., RRCSetupComplete message or RRCConnectionSetupComplete message) to the RAN 105. In some implementations, the UE 102 configures a first SRB (e.g., SRB1) to communicate RRC messages with the RAN 105 in response to the RRC response message. In such implementations, the UE 102 transmits the RRC complete message via the first SRB to the RAN 105. In some implementations, the UE 102 can send a Service Request message to the CN 110 via the RAN 105 after transitioning 428 to the connected state. In one implementation, the UE 102 can include the Service Request message in the RRC complete message. The RAN 105 retrieves the Service Request message from the RRC complete message and sends a first BS-to-CN message (e.g., Initial UE Message message) including the Service Request message to the CN 110.

After performing 426 the RRC connection establishment procedure with the UE 102 or transitioning 428 the UE 102 to the connected state, the RAN 105 can perform 430 a security activation procedure (e.g., RRC security mode procedure) with the UE 102 to activate security (e.g., integrity protection/integrity check and/or encryption/decryption) on communication with the UE 102. In some implementations, the RAN 105 sends a security activation command message (e.g., SecurityModeCommand message) to the UE 102, e.g., via the SRB, to perform 430 the security activation procedure. In response, the UE 102 activates security (e.g., integrity protection and/or encryption) on communication with the RAN 105 and transmits a security activation complete message (e.g., SecurityModeComplete) to the RAN 105, e.g., via the SRB. After activating the security, the RAN 105 can perform a RRC reconfiguration (not shown in FIG. 4A) with the UE 102 to configure a second SRB (e.g., SRB2) and/or a DRB to exchange RRC messages and/or NAS message with the UE 102.

After transitioning 428 to the connected state or performing 430 the security activation procedure, the UE 102 can perform 432 an MBS session join procedure (a.k.a., an MBS session activation procedure or MBS session establishment procedure) with the CN 110 via the RAN 105, which indicates that the UE 102 is requesting to join the MBS session. In some implementations, the UE 102 makes the request if the UE 102 does not have an MBS context for receiving the MBS session. In cases where the UE 102 has an MBS context for receiving the MBS session before receiving the message including the MBS session ID in the MBS session activation notification procedure 490, the UE 102 can skip, omit or refrain from performing the MBS session join procedure. In some implementations, to perform 432 the MBS session join procedure, the UE 102 sends an MBS session join request message (a.k.a., MBS session activation request message or MBS session establishment request message) to the CN 110 via the RAN 105. In response, the CN 110 can send an MBS session join accept message (a.k.a., MBS session activation accept message or MBS session establishment accept message) to the UE 102 via the RAN 105. In some implementations, the UE 102 performs the MBS session join procedure after activating 430 the security. Thus, the security protects the MBS session join procedure. Upon receiving the MBS session join request message from the UE 102, the RAN 105 can send a second BS-to-CN message (e.g., Uplink NAS Transport message) including the MBS session join request message to the CN 110. In other implementations, the UE 102 can perform the MBS session join procedure after transitioning 428 to the connected state and before activating the security. In further implementations, the UE 102 includes the MBS session join request message in the RRC complete message. The RAN 105 retrieves the MBS session join request from the RRC complete message and sends the first BS-to-CN message including the MBS session join request message to the CN 110. In such implementations, the UE 102 may determine not to send the Service Request message.

In alternative implementations, the UE 102 performs the MBS session join procedure with the MBS network 170 via the CN 110 and the RAN 105, instead of the CN 110. In such cases, the CN 110 sends the MBS session join request message to the MBS network 170 and receives the MBS session join accept message from the MBS network 170, respectively.

In some implementations, the MBS context includes the MBS session ID. In further implementations, the MBS context can include a QoS profile of the MBS session, an IP address for the MBS session, and/or one or more MRB configurations configuring one or more MRBs.

In some implementations, the CN 110 can initiate the MBS resource setup procedure 492 in response to or after receiving the first BS-to-CN message or the second BS-to-CN message. In response to or after receiving the MBS Resource Setup Request message, the RAN 105 can perform 434 an RRC reconfiguration procedure with the UE 102 to configure radio resources for the UE 102 to receive 494 MBS data of the MBS session. To perform 434 the RRC reconfiguration procedure, the RAN 105 sends an RRC reconfiguration message to the UE 102. In some implementations, the RAN 105 includes, in the RRC reconfiguration message, configuration parameters for the UE 102 to receive 494 MBS data of the MBS session. In further implementations, the RAN 105 sets the configuration parameters in accordance with the QoS profile. The UE 102 receives the MBS data in the MBS data transmission procedure 494 in accordance with the configuration parameters. Depending on the implementation, the configuration parameters may include physical layer configuration parameter(s), MAC configuration parameter(s), RLC configuration parameter(s), PDCP configuration parameter(s), SDAP configuration parameter(s) and/or MRB configuration parameter(s). In some further implementations, MRB configuration parameter(s) configure one or more MRBs associated with the MBS session.

In response to the RRC reconfiguration message, the UE 102 can send an RRC reconfiguration complete message to the RAN 105. In some implementations, the RAN 105 sends the MBS Resource Setup Response message to the CN 110 before or after receiving the RRC reconfiguration complete message. In other implementations, the CN 110 performs 492 the MBS resource setup procedure with the RAN 105 before receiving the first BS-to-CN message or the second BS-to-CN message. In yet other implementations, the CN 110 performs 492 the MBS resource setup procedure with the RAN 105 irrespective of receiving the first BS-to-CN message or performing the MBS session join procedure.

After receiving 414 the MBS Session Start Acknowledge message, the MBS network 170 can perform 494 an MBS data transmission procedure to send MBS data to the UE 102. In some implementations, when the RAN 105 receives MBS data from the CN 110 during the MBS data transmission procedure, the RAN 105 transmits the MBS data to the UE 102 via multicast. After performing the RRC reconfiguration procedure, the UE 102 uses the configuration parameters to receive the MBS data from the RAN 105. In some implementations, the RAN 105 transmits the MBS data to the UE 102 via the one or more MRBs and the UE 102 receives the MBS data via the one or more MRBs.

Turning to FIG. 4B, a scenario 400B is similar to the scenario 400A, except that the UE 102 initially operates 403 in an inactive state (e.g., RRC_INACTIVE), and in response to receiving the MBS activation notification message, the UE 102 performs an RRC resume procedure with the RAN 105 rather than the RRC connection establishment procedure. In some scenarios and implementations, the UE 102 communicates in a connected state with the RAN 105, before the UE 102 begins operating 403 in the inactive state. The UE 102 in the connected state communicates data with the RAN 105, e.g., via one or more radio bearers (RBs). In some implementations, the UE 102 in the connected state communicates the control-plane (CP) data via one or more signaling RBs (SRBs). In some implementations, the UE 102 in the connected state communicates the user-plane (UP) data via one or more data RBs (DRBs).

After a certain period of data inactivity for the UE 102, the RAN 105 can determine that neither the RAN 105 nor the UE 102 has transmitted any data in the downlink direction or the uplink direction, respectively, during the period. In response to the determination, the RAN 105 can transmit an RRC release message (e.g., RRCRelease message or RRCConnectionRelease message) to the UE 102 and instruct the UE 102 to transition to the inactive state. The UE 102 transitions to the inactive state upon receiving the RRC release message. In some implementations, the RAN 105 assigns an I-RNTI or a resume ID to the UE 102 and includes the assigned value in the RRC release message. In further implementations, after the UE 102 transitions to the inactive state, the UE 102 performs one or more RAN notification area (RNA) updates with the RAN 105 without state transitions.

In response to the activation 418, the UE 102 can perform 427 an RRC resume procedure with the RAN 105. The UE 102 transitions 428 to a connected state (e.g., RRC_CONNECTED state) in response to the RRC resume procedure. In some implementations, to perform 427 the RRC resume procedure, the UE 102 performs 424 a random access procedure with the RAN 105 to synchronize with the RAN 105 in uplink transmission, such as in cases where the UE 102 is not uplink synchronized with the RAN 105 (i.e., the UE 102 does not have a valid timing advance command or value with the RAN 105). To perform 427 the RRC resume procedure, the UE 102 transmits a RRC request message (e.g., RRCResumeRequest message or RRCConnectionResumeRequest message) to the RAN 105. Depending on the implementation, the random access procedure can be a two-step or four-step random access procedure. In cases where the UE 102 performs 424 the two-step random access procedure, the UE 102 transmits the RRC request message in a message (e.g., message A) of the two-step random access procedure. In cases where the UE 102 performs 424 the four-step random access procedure, the UE 102 transmits the RRC request message in a message (e.g., message 3) of the four-step random access procedure. In cases where the UE 102 is uplink synchronized with the RAN 105 and has a configured grant configuration for the idle state, the UE 102 can skip or omit the random access procedure. In such cases, the UE 102 can transmit the RRC request message using a configured grant that is configured by the configured grant configuration.

In response to the RRC request message, the RAN 105 can transmit an RRC response message (e.g., RRCResume message or RRCConnectionResume message) to the UE 102. In response, the UE 102 transitions 428 to the connected state and transmits an RRC complete message (e.g., RRCResumeComplete message or RRCConnectionResumeComplete message) to the RAN 105. In some implementations, the UE 102 operating 403 in the inactive state suspends a first SRB (e.g., SRB1), a second SRB and/or one or more DRBs. In such implementations, the UE 102 resumes the first SRB to receive the RRC response message in response to or after transmitting the RRC request message and transmits the RRC complete message via the first SRB to the RAN 105. The UE 102 can resume the second SRB in response to the RRC response message. In some implementations, the UE 102 resumes the one or more DRBs in response to the RRC response message, such as in cases where the RAN 105 does not indicate release of the one or more DRBs in the RRC response message. In some further implementations, the UE 102 may not send a Service Request message to the CN 110 via the RAN 105 after transitioning 428 to the connected state, unlike FIG. 4A.

In some implementations, the UE 102 operating 403 in the inactive state has an MBS context for the MBS session as described for FIG. 4A. The UE 102 in the inactive state suspends one or more MRBs in the MBS context. In such implementations, the UE 102 resumes one or more MRBs in response to the RRC response message, such as in cases where the RAN 105 does not indicate release of the one or more MRBs in the RRC response message.

In some implementations, the UE 102 in the MBS data transmission procedure 494 receives MBS data of the MBS session (i.e., a first MBS session) via (one, some, or all of) the one or more MRBs that the UE 102 resumed in response to the RRC resume procedure. In such implementations, the UE 102 refrains from performing an MBS session join procedure to active reception of the MBS session. In other implementations, the UE 102 performs 432 the MBS session join procedure, such as in cases where the UE 102 does not have an MBS context for the MBS session. In some scenarios and implementations, the UE 102 has an MBS context for a second MBS session and resumes one or more MRBs for the second MBS session in response to the RRC resume procedure or the RRC response message. In such cases, the UE 102 cannot receive MBS data of the first MBS session via the one or more MRBs of the MBS context for the second MBS session. Thus, the UE 102 performs the MBS session join procedure to cause the RAN 105 to perform 434 the RRC reconfiguration procedure to configure radio resources for the UE 102 to receive MBS data of the first MBS session. The UE 102 receives the MBS data in the MBS data transmission procedure 494 in accordance with the configuration parameters. Depending on the implementation, the configuration parameters may include physical layer configuration parameters, MAC configuration parameters, RLC configuration parameters, PDCP configuration parameters, SDAP configuration parameters and/or MRB configuration parameters.

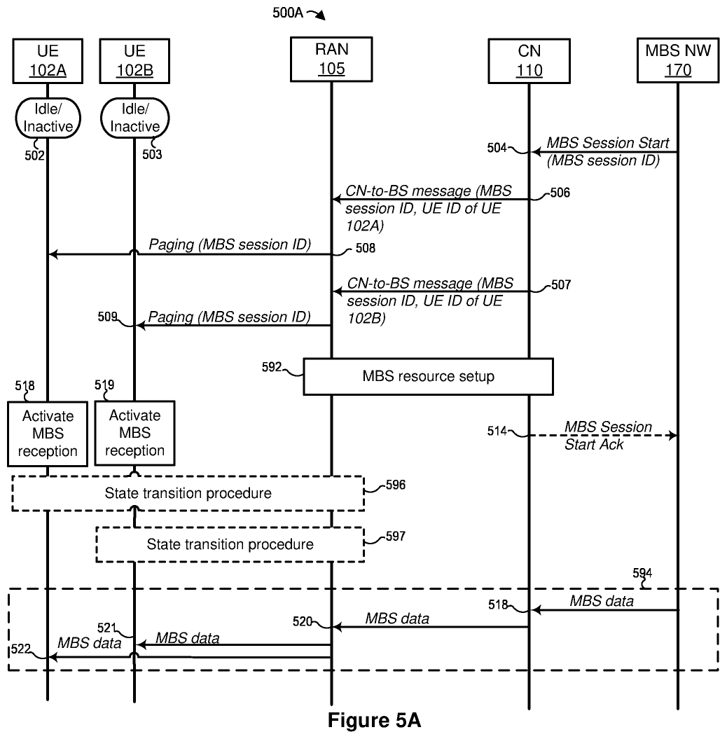

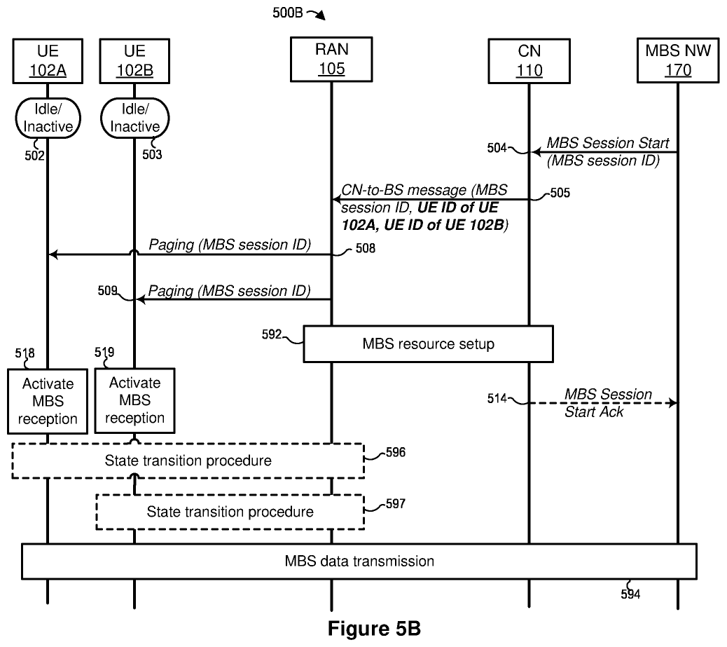

FIG. 5A and FIG. 5B are example message sequences similar to the message sequences of FIGS. 3, 4A and 4B, but where the RAN 105 pages the UE 102A and UE 102B respectively in separate paging messages.

In FIG. 5A, the CN 110 sends 506 a first CN-to-BS message and 507 a second CN-to-BS message to the RAN 105 to page the UE 102A and UE 102B, respectively, in response to or after receiving 504 an MBS Session Start message including an MBS session ID. More specifically, the CN 110 includes the MBS session ID and a UE ID of the UE 102A in the first CN-to-BS message, and the CN 110 includes the MBS session ID and a UE ID of the UE 102B in the second CN-to-BS message.

In response to or after receiving 506 the first CN-to-BS message, the RAN 105 can transmit 508 a paging message in a first paging occasion. In response to or after receiving 507 the second CN-to-BS message, the RAN 105 can transmit 509 a paging message in a second paging occasion. In some implementations, the RAN 105 determines or derives the first paging occasion based on the UE ID of the UE 102A, a first paging DRX cycle configuration, a search space configuration (e.g., pagingSearchSpace), and/or PDCCH monitoring configuration(s) (e.g., firstPDCCH-MonitoringOccasionOfPO and nrofPDCCH-MonitoringOccasionPerSSB-InPO). Similarly, in some implementations, the RAN 105 determines or derives the second paging occasion based on the UE ID of the UE 102B, a second paging DRX cycle configuration, the search space configuration and/or the PDCCH monitoring configuration(s).

In some implementations, the first and second paging DRX cycle configurations are identical (i.e., the same content). In other implementations, the first and second paging DRX cycle configurations are different. In some implementations, the CN 110 includes the first paging DRX cycle configuration and the second paging DRX cycle configuration in the first and second CN-to-BS messages, respectively. In other implementations, the RAN 105 determines the first and second paging DRX cycle configurations and transmits the first and second paging DRX cycle configurations to the UE 102A and UE 102B respectively. In cases where the first and second paging DRX cycle configurations are the same paging DRX cycle configurations, the RAN 105 can broadcast the paging DRX cycle configuration in system information.

In response to or after receiving 508 the paging message, the UE 102A in some implementations receives 522 MBS data without transitioning to the connected state, as described for FIG. 3. Similarly, in response to or after receiving 509 the paging message, the UE 102B in some implementations receives 522 MBS data without transitioning to the connected state, as described for FIG. 3. In other implementations, in response to or after receiving 508 the paging message, the UE 102A performs 596 a state transition procedure, similar to event 496 or 497. After transitioning to the connected state, the UE 102A in the connected state receives 522 the MBS data. Similarly, in response to or after receiving 509 the paging message, the UE 102B in some implementations performs 597 a state transition procedure, similar to event 496 or 497. After transitioning to the connected state, the UE 102B in the connected state receives 522 the MBS data.

Turning to FIG. 5B, a scenario 500B is similar to the scenario 500A, except that the CN 110 sends 505 a single CN-to-BS message to the RAN 105 to cause the RAN 105 to page the UE 102A and UE 102B, instead of sending 506, 507 the first and second CN-to-BS messages. The CN 110 can include the UE ID of the UE 102A and the UE ID of the UE 102B in the CN-to-BS message. In some implementations, the CN 110 includes the first and second paging DRX cycle configurations in the CN-to-BS message. In cases where the first and second paging DRX cycle configurations are the same, the CN 110 can include a single paging DRX cycle configuration (i.e., the first paging DRX cycle configuration) in the CN-to-BS message.

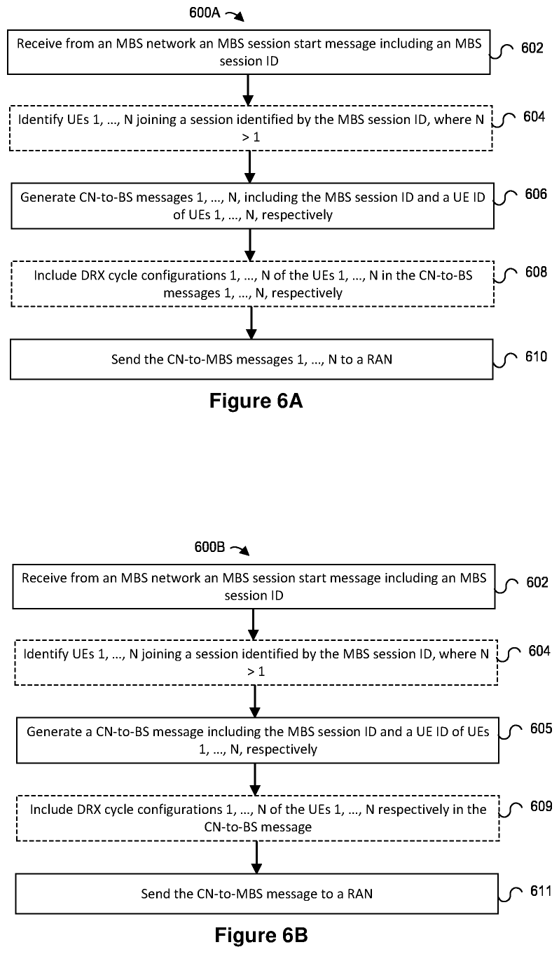

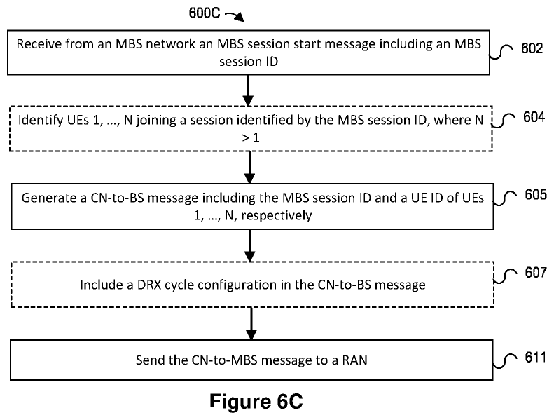

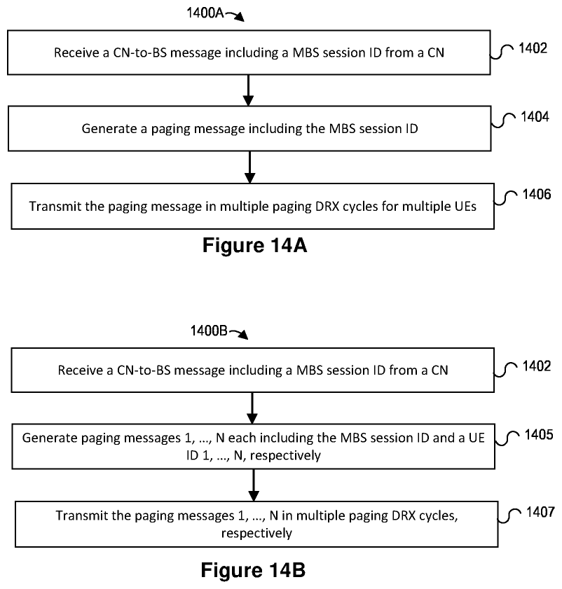

FIGS. 6-13 are flow diagrams depicting example methods that a CN (e.g., the CN 110, the AMF 164 or the MME 114) can implement to page UEs for an MBS. FIGS. 14A and 14B are flow diagrams depicting example methods that a RAN (e.g., the RAN 105, the base stations, 104, 106A, 106B or the CU 172 and/or the DU 174) can implement to page UEs for an MBS.

Blocks in FIGS. 6A-6C that are the same are labeled with the same reference numbers. For clarity, the methods 600A-600C are discussed with specific reference to the RAN 105 and the CN 110.

FIG. 6A is a flow diagram of an example method 600A for paging UEs for an MBS. At block 602, the CN 110 receives, from an MBS network, an MBS session start message including an MBS session ID (e.g., event 304, 490, 504). In some implementations, at block 604, the CN 110 identifies UEs 1, . . . , N joining a session identified by the MBS session ID, where N>1. At block 606, the CN 110 generates CN-to-BS messages 1, . . . , N, including the MBS session ID and a UE ID of UEs 1, . . . , N, respectively (e.g., events 506, 507). In some implementations, at block 608, the CN 110 includes DRX cycle configurations 1, . . . , N of the UEs 1, . . . , N in the CN-to-BS messages 1, . . . , N, respectively (e.g., events 506, 507). At block 610, the CN 110 sends the CN-to-MBS messages 1, . . . , N to a RAN 105 (e.g., events 506, 507).

FIG. 6B is a flow diagram of an example method 600B for paging UEs for an MBS. At block 602, the CN 110 receives, from an MBS network, an MBS session start message including an MBS session ID (e.g., event 304, 490, 504). In some implementations, at block 604, the CN 110 identifies UEs 1, . . . , N joining a session identified by the MBS session ID, where N>1. At block 605, the CN 110 generates a CN-to-BS messages including the MBS session ID and a UE ID for each of UEs 1, . . . , N (e.g., events 505). In some implementations, at block 609, the CN 110 includes DRX cycle configurations 1, . . . , N of the UEs 1, . . . , N in the CN-to-BS message (e.g., event 505). At block 611, the CN 110 sends the CN-to-MBS message to a RAN 105 (e.g., event 505).

FIG. 6C is a flow diagram of an example method 600C for paging UEs for an MBS. At block 602, the CN 110 receives, from an MBS network, an MBS session start message including an MBS session ID (e.g., event 304, 490, 504). At block 604, the CN 110 identifies UEs 1, . . . , N joining a session identified by the MBS session ID, where N>1. At block 605, the CN 110 generates a CN-to-BS messages including the MBS session ID and a UE ID of UEs 1, . . . , N (e.g., events 505). At block 607, the CN 110 includes a DRX cycle configuration in the CN-to-BS message (e.g., event 505). At block 611, the CN 110 sends the CN-to-MBS message to a RAN 105 (e.g., event 505).

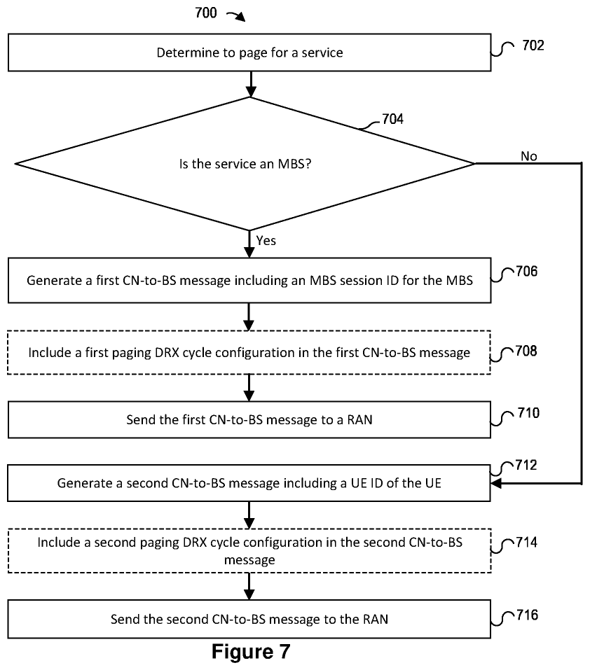

FIG. 7 is a flow diagram of an example method 700 for paging UE(s) an MBS. For clarity, the method 700 is discussed with specific reference to the RAN 105, the UE 102, and the CN 110.

At block 702, the CN 110 determines to page for a service. At block 704, the CN 110 determines whether the service an MBS. If the service is an MBS, the flow proceeds to blocks 706, 708, and 710. In some implementations, the flow proceeds directly from block 706 to block 710. At block 706, the CN 110 generates a first CN-to-BS message including an MBS session ID for the MBS (e.g., events 306, 490). At block 708, the CN 110 includes a first paging DRX cycle configuration in the first CN-to-BS message (e.g., events 306, 490). At block 710, the CN 110 sends the first CN-to-BS message to a RAN 105. If the service is not an MBS (i.e., the CN 110 pages a UE 102 for a unicast service such as a voice call or an Internet service (e.g., What's APP, LINE, email, YouTube, a Google service)), the flow proceeds to block 712, 714, 716. In some implementations, the flow proceeds directly from block 712 to block 716. At block 712, the CN 110 generates a second CN-to-BS message including a UE ID of the UE 102 (e.g., 5G-S-TMSI). At block 714, the CN 110 includes a second DRX configuration in the second CN-to-BS message. At block 716, the CN 110 sends the second CN-to-BS message to the RAN 105.

In some implementations, the first and second CN-to-BS messages are NGAP Paging messages. In other implementations, the first and second CN-to-BS messages are a new NGAP message (e.g., specific for MBS) and an NGAP Paging message, respectively.

In some implementations, the CN 110 at block 710 sends the first CN-to-BS message to at least one first RAN node (e.g., base station(s) and CU(s)) of the RAN 105 and, at block 716, sends the second CN-to-BS message to at least one second RAN node (e.g., base station(s) and CU(s)) of the RAN 105. The at least one first RAN node and the at least one second RAN node can include the same RAN node(s) and/or different RAN node(s).

In some implementations, the first paging DRX cycle configuration is an MBS (paging) DRX configuration or a grouping paging DRX cycle configuration. In some implementations, the second paging DRX cycle configuration is a UE specific DRX cycle configuration or a DRX cycle configuration for unicast paging.

In some implementations, the CN 110 refrains from including a UE radio capability for paging in the first CN-to-BS message. In other implementations, the CN 110 includes a common UE radio capability for paging in the first CN-to-BS message. The common UE radio capability for paging includes one or more capabilities common for plural UEs. In some implementations, the CN 110 includes a UE radio capability for paging in the second CN-to-BS message.

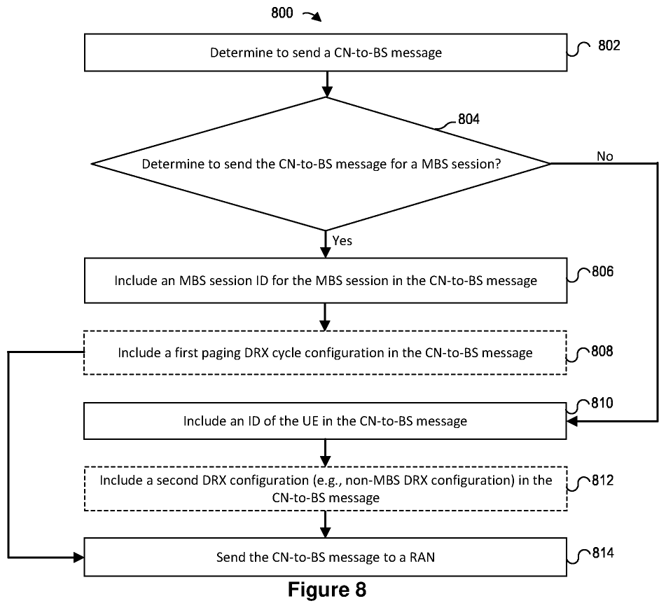

FIG. 8 is a flow diagram of an example method 800 for paging UE(s) for an MBS. For clarity, the method 800 is discussed with specific reference to the RAN 105, the UE 102, and the CN 110.

At block 802, the CN 110 determines to send a CN-to-BS message. At block 804, the CN 110 determines whether to send the CN-to-BS message for an MBS session (or an MBS session ID). If the CN 110 determines to send the CN-to-BS message for an MBS session, the flow proceeds to blocks 806, 808, and 814. In some implementations, the flow proceeds directly from block 806 to block 814. If the CN 110 determines to send the CN-to-BS message for a service other than an MBS session (e.g., a unicast service described for FIG. 7), the flow proceeds to blocks 810, 812, and 814. In some implementations, the flow proceeds directly from block 810 to block 814. At block 806, the CN 110 includes an MBS session ID for the MBS session in the CN-to-BS message (e.g., events 306, 490). At block 808, the CN 110 includes a first paging DRX cycle configuration in the CN-to-BS message (e.g., events 306, 490). At block 810, the CN 110 includes an ID of the UE 102 (e.g., 5G-S-TMSI) in the CN-to-BS message. At block 812, the CN 110 includes a second paging DRX cycle configuration in the CN-to-BS message. At block 814, the CN 110 sends the CN-to-BS message to a RAN 105.

In some implementations, the CN-to-BS messages are NGAP Paging messages. In some implementations, the first paging DRX cycle configuration is an MBS (paging) DRX configuration or a grouping paging DRX cycle configuration. In some implementations, the second paging DRX cycle configuration is a UE specific DRX cycle configuration or a DRX cycle configuration for unicast paging.

In some implementations, the CN 110 at block 814 sends the CN-to-BS message to at least one first RAN node (e.g., base station(s) and CU(s)) of the RAN 105, such as in cases where the service is an MBS. In further implementations, the CN 110 at block 814 sends the CN-to-BS message to at least one second RAN node (e.g., base station(s) and CU(s)) of the RAN 105, such as in cases where the service is not an MBS (e.g., a unicast service as described for FIG. 7). The at least one first RAN node and the at least one second RAN node can include the same RAN node(s) and/or different RAN node(s).

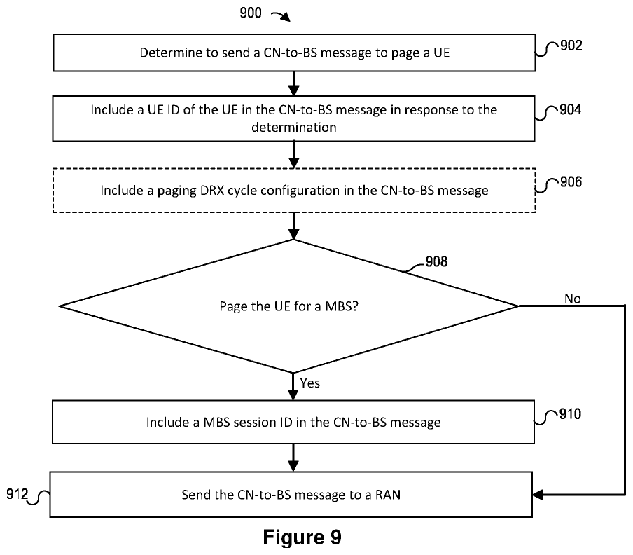

FIG. 9 is a flow diagram of an example method 900 for paging UE(s) for an MBS. For clarity, the method 900 is discussed with specific reference to the RAN 105, the UE 102, and the CN 110.

At block 902, the CN 110 determines to send a CN-to-BS message to page a UE 102 (e.g., events 390, 490, 506, 507, 505). At block 904, the CN includes a UE ID of the UE 102 (e.g., 5G-S-TMSI) in the CN-to-BS message in response to the determination. At block 906, the CN 110 includes a paging DRX cycle configuration in the CN-to-BS message (e.g., events 390, 490, 506, 507, 505). At block 908, the CN 110 determines whether the CN 110 pages the UE 102 for an MBS. If the CN 110 pages the UE 102 for an MBS, the flow proceeds to blocks 910 and 912. If the CN 110 pages the UE 102 for a service other than an MBS (e.g., a unicast service as described above), the follow proceeds to block 912. At block 910, the CN 110 includes an MBS session ID in the CN-to-BS message. At block 912, the CN 110 sends the CN-to-BS message to a RAN 105 (e.g., events 390, 490, 506, 507, 505). In some implementations, the flow continues from block 904 directly to block 908.

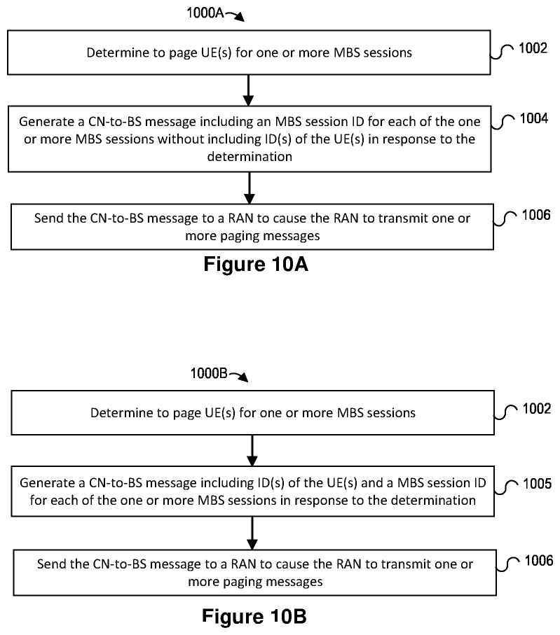

Blocks in FIGS. 10A-10B that are the same are labeled with the same reference numbers. For clarity, the methods 1000A and 1000B are discussed with specific reference to the RAN 105 and the CN 110.

FIG. 10A is a flow diagram of an example method 1000A for paging UE(s) for an MBS. At block 1002, the CN 110 determines to page UE(s) for one or more MBS sessions. At block 1004, the CN 110 generates a CN-to-BS message including an MBS session ID for each of the one or more MBS sessions without including ID(s) of the UE(s) in response to the determination (e.g., events 306, 490). At block 1006, the CN 110 sends the CN-to-BS message to a RAN 105 to cause the RAN 105 to transmit one or more paging messages (e.g., events 306, 490).

FIG. 10B is a flow diagram of an example method 1000B for paging UE(s) for an MBS. At block 1002, the CN 110 determines to page UE(s) for one or more MBS sessions. At block 1005, the CN 110 generates a CN-to-BS message including ID(s) of the UE(s) and an MBS session ID for each of the one or more MBS sessions in response to the determination (e.g., events 505, 506, 507). At block 1006, the CN 110 sends the CN-to-BS message to a RAN 105 to cause the RAN 105 to transmit one or more paging messages (e.g., events 505, 506, 507).

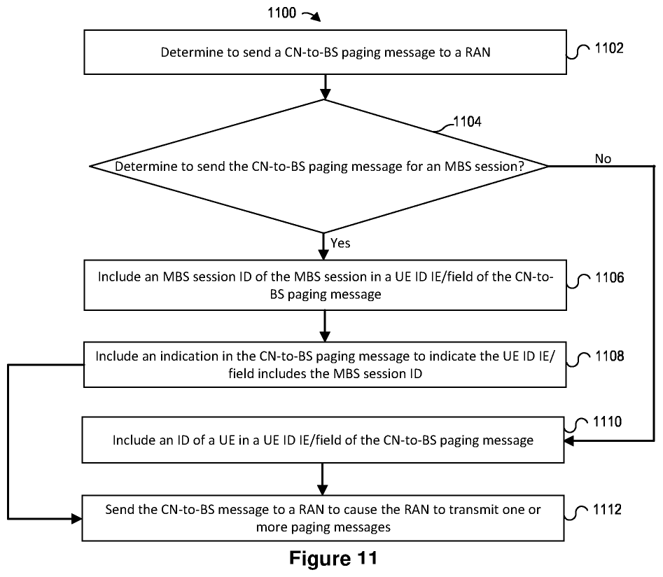

FIG. 11 is a flow diagram of an example method 1100 for paging UE(s) for an MBS. For clarity, the method 1100 is discussed with specific reference to the RAN 105, the UE 102, and the CN 110.

At block 1102, the CN 110 determines to send a CN-to-BS paging message to a RAN 105 (e.g., events 306, 490). At block 1104, the CN 110 determines whether to send the CN-to-BS paging message for an MBS session (e.g., events 306, 490). If the CN 110 sends the CN-to-BS paging message for an MBS session, the flow proceeds to blocks 1106, 1108 and 1112. If the CN 110 sends the CN-to-BS paging message for a service other than an MBS session (e.g., a unicast service described above), the flow proceeds to block 1110 and 1112. At block 1106, the CN 110 includes an MBS session ID of the MBS session in a UE ID IE/field of the CN-to-BS paging message (e.g., events 306, 490). At block 1108, the CN 110 includes an indication in the CN-to-BS paging message to indicate the UE ID IE/field includes the MBS session ID (e.g., events 306, 490). At block 1110, the CN 110 includes an ID of a UE 102 (e.g., 5G-S-TMSI) in a UE ID IE/field of the CN-to-BS paging message. At block 1112, the CN 110 sends the CN-to-BS message to a RAN 105 to cause the RAN 105 to transmit one or more paging messages (e.g., events 306, 490).

In some implementations, the CN 110 at block 1112 sends the CN-to-BS message to at least one first RAN node (e.g., base station(s) and CU(s)) of the RAN 105, such as in cases where the CN 110 sends the CN-to-BS message for an MBS session. The CN 110 at block 1112 can send the CN-to-BS message to at least one second RAN node (e.g., base station(s) and CU(s)) of the RAN 105, such as in cases where the CN 110 sends the CN-to-BS message for a service other than an MBS session. The at least one first RAN node and the at least one second RAN node can include the same RAN node(s) and/or different RAN node(s).

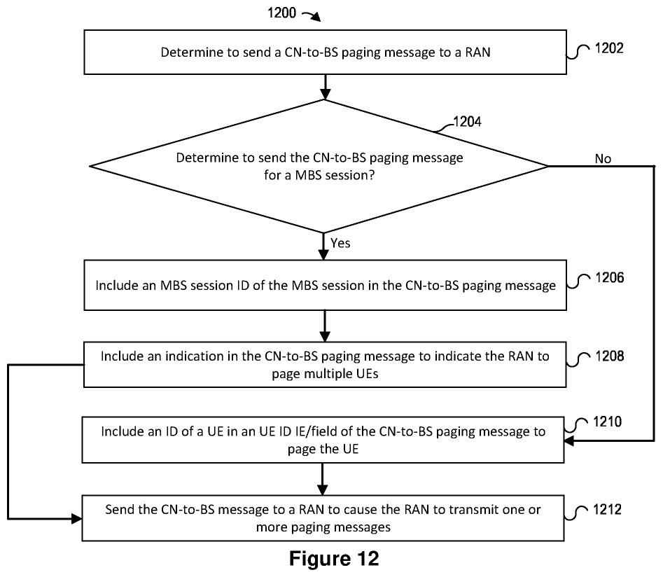

FIG. 12 is a flow diagram of an example method 1200 for paging UE(s) for an MBS. For clarity, the method 1200 is discussed with specific reference to the RAN 105, the UE 102, and the CN 110.

At block 1202, the CN 110 determines to send a CN-to-BS paging message to a RAN 105 (e.g., events 306, 490). At block 1204, the CN 110 determines whether to send the CN-to-BS paging message for an MBS session (e.g., events 306, 490). If the CN 110 sends the CN-to-BS paging message for an MBS session, the flow proceeds to blocks 1206, 1208 and 1212. If the CN 110 sends the CN-to-BS paging message for a service other than an MBS session (e.g., a unicast service described above), the flow proceeds to block 1210 and 1212. At block 1206, the CN 110 includes an MBS session ID of the MBS session in the CN-to-BS paging message (e.g., events 306, 490). At block 1208, the CN 110 includes an indication (e.g., group paging indication) in the CN-to-BS paging message to indicate to the RAN 105 to page multiple UEs (e.g., events 306, 490). At block 1210, the CN 110 includes an ID of a UE 102 (e.g., 5G-S-TMSI) in a UE ID IE/field of the CN-to-BS paging message. At block 1212, the CN 110 sends the CN-to-BS message to a RAN 105 to cause the RAN 105 to transmit one or more paging messages (e.g., events 306, 490).

In some implementations, the CN at block 1212 sends the CN-to-BS message to at least one first RAN node (e.g., base station(s) and CU(s)) of the RAN 105, such as in cases where the CN 110 sends the CN-to-BS message for an MBS session. In further implementations, the CN 110 at block 1212 sends the CN-to-BS message to at least one second RAN node (e.g., base station(s) and CU(s)) of the RAN 105, such as in cases where the CN 110 sends the CN-to-BS message for a service other than an MBS session. The at least one first RAN node and the at least one second RAN node can include the same RAN node(s) and/or different RAN node(s).

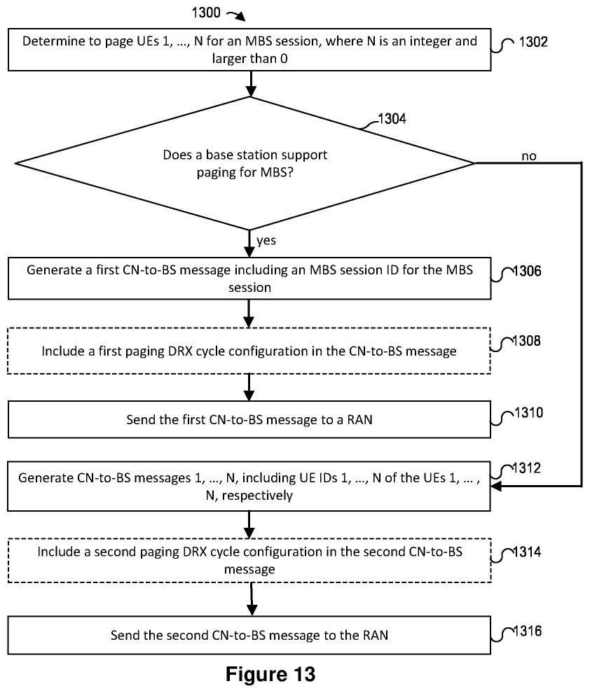

FIG. 13 is a flow diagram of an example method 1300 for paging UE(s) for an MBS, similar to the method 700 of FIG. 7. For clarity, the method 1300 is discussed with specific reference to the RAN 105 and the CN 110.

At block 1302, the CN 110 determines to page UEs 1, . . . , N for an MBS session, where N is an integer and larger than 0. At block 1304, the CN 110 determines whether a base station supports paging for MBS. If the base station supports paging for MBS, the flow proceeds to blocks 1306, 1308 and 1310. In some implementations, the flow continues from block 1306 directly to block 1310. If the base station does not support paging for MBS, the flow proceeds to blocks 1312, 1314 and 1316. In some implementations, the flow continues from block 1312 directly to block 1316. At block 1306, the CN 110 generates a first CN-to-BS message including an MBS session ID for the MBS session. At block 1308, the CN 110 includes a first paging DRX cycle configuration in the CN-to-BS message. At block 1310, the CN 110 sends the first CN-to-BS message to a RAN 105. At block 1312, the CN 110 generates CN-to-BS messages 1, . . . , N, including UE IDs 1, . . . , N of the UEs 1, . . . , N. respectively. At block 1314, the CN 110 includes a second paging DRX cycle configuration in the second CN-to-BS message. At block 1316, the CN 110 sends the second CN-to-BS message to a RAN 105.

Blocks in FIGS. 14A-14B that are the same are labeled with the same reference numbers. For clarity, the methods 1400A and 1400B are discussed with specific reference to the base station 104, the UE 102, and the CN 110.

FIG. 14A is a flow diagram of an example method 1400A for paging UE(s) for an MBS. At block 1402, the base station 104 receives a CN-to-BS message including an MBS session ID from a CN 110 (e.g., events 306, 490, 505). At block 1404, the base station 104 generates a paging message including the MBS session ID (e.g., events 308, 490, 508, 509). At block 1406, the base station 104 transmits the paging message in multiple paging DRX cycles for multiple UEs (e.g., events 308, 490, 508, 509).

FIG. 14B is a flow diagram of an example method 1400B for paging UE(s) for an MBS. At block 1402, the base station 104 receives a CN-to-BS message including an MBS session ID from a CN 110 (e.g., events 308, 490, 505). At block 1405, the base station 104 generates paging messages 1, . . . , N each including the MBS session ID and a UE ID 1 . . . . N, respectively (e.g., events 308, 490, 508, 509). At block 1407, the base station 104 transmits the paging messages 1, . . . , N in multiple paging DRX cycles (e.g., events 308, 490, 508, 509). For example, the base station 104 transmits the paging messages 1, . . . , N in paging DRX cycles 1, . . . , N, respectively. In another example, the base station transmits the paging messages 1, . . . , N in paging DRX cycles 1, . . . , M, where 1<M<N.

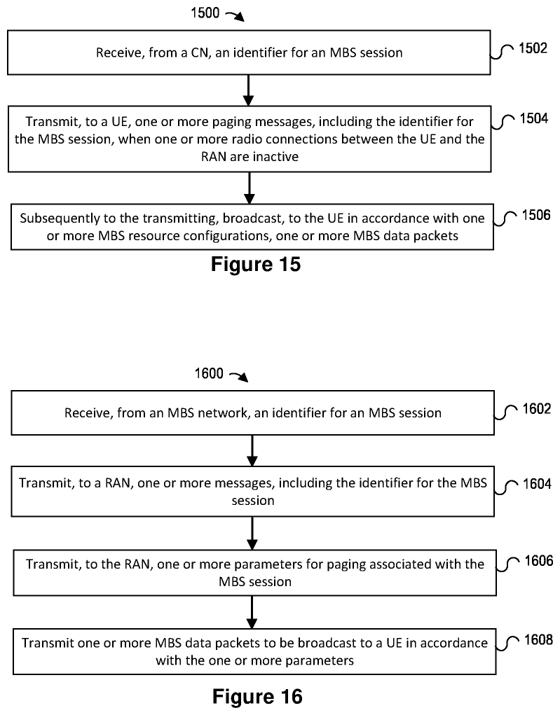

FIG. 15 is a flow diagram of an example method 1500 for managing paging for multicast and broadcast services, implemented in a RAN. At block 1502, the RAN 105 receives, from a CN 110, an identifier for an MBS session and an indication to page a UE 102 participating in the MBS session (e.g., events 306, 490, and 505/506/507 and block 1402 of FIGS. 3-5B, 14A, and 14B). At block 1504, the RAN 105 transmits, to a UE 102, one or more paging messages, including the identifier for the MBS session, when one or more radio connections between the UE 102 and the RAN 105 are inactive (e.g., events 308, 490, and 508/509 and blocks 1404/1405/1406/1407 of FIGS. 3-5B, 14A, and 14B). At block 1506, the RAN 105, subsequently to the transmitting, broadcasts, to the UE 102 in accordance with one or more MBS resource configurations, one or more MBS data packets (e.g., events 322, 494, and 521/522 of FIGS. 3-5B).

FIG. 16 is a flow diagram of an example method 1600 for managing paging for multicast and broadcast services, implemented in a CN. At block 1602, the CN 110 receives, from an MBS network 170, an identifier for an MBS session (e.g., events 304, 490, and 504 and 602, 702, 802, 902, 1002, 1102, 1202, and 1302 of FIGS. 3-13). At block 1604, the CN 110 transmits, to a RAN 105, one or more messages, including the identifier for the MBS session (e.g., events 306, 490, and 505/506/507 and blocks 605/606/610/611, 706/710, 806/814, 910/912, 1004/1005/1006, 1106/1112, 1206/1212, and 1306/1310 of FIGS. 3-13). At block 1606, the CN 110 transmits, to the RAN 105, one or more parameters associated with the MBS session (e.g., events 310, 492, and 592 and blocks 604/607/608/609/610/611, 708/710, 808/814, 904/906/912, 1004/1005/1006, 1108/1112, 1208/1212, and 1308/1310 of FIGS. 3-13). At block 1608, the CN 110 transmits one or more MBS data packets to be broadcast to a UE 102 in accordance with the one or more parameters (e.g., events 320, 494, and 520 of FIGS. 3-5B).

The following list of examples reflects a variety of the embodiments explicitly contemplated by the present disclosure:
Example 1. A method for managing paging for multicast and broadcast services (MBS), the method implemented in a core network (CN) and comprising: receiving, by processing hardware and from an MBS network, an identifier for an MBS session; transmitting, by the processing hardware to a radio access network (RAN), a message including the identifier for the MBS session; transmitting, by the processing hardware to the RAN, one or more parameters associated with the MBS session; and transmitting, by the processing hardware to the RAN, one or more MBS data packets to be broadcast to a user equipment (UE) in accordance with the one or more parameters.
Example 2. The method of example 1, wherein the UE is a first one of a plurality of UEs, the method further comprising: identifying a set of UEs of the plurality of UEs to join the MBS session; and generating a message of the one or more messages including the identifier for the MBS session and an identifier for each UE of the set of UEs.
Example 3. The method of example 2, wherein the message further includes a paging cycle configuration for each of at least some of the set of UEs or a paging cycle configuration for the MBS session.
Example 4. The method of any of examples 1-3, wherein the message is an MBS message of one or more messages further comprising: determining to transmit a first message of the one or more messages to the RAN; determining whether to transmit the MBS message as the first message or to transmit a UE message including an identifier for the UE as the first message based on whether the CN determines to transmit the first message for an MBS session.
Example 5. The method of any of examples 1-4, wherein the UE is a first one of a plurality of UEs and the message is an MBS message of one or more messages, further comprising: determining to page the plurality of UEs for an MBS session; and determining whether to generate the MBS message or a plurality of UE messages, each UE message of the plurality of UE messages including an identifier for a different UE of the plurality of UEs, based on whether a base station of the RAN supports paging for MBS.
Example 6. The method of any of examples 1-4, wherein the message is an MBS message of a plurality of messages further comprising: determining to transmit a first message to the RAN to page the UE; and determining whether to transmit the MBS message as the first message based on whether the RAN pages the UE for an MBS session.
Example 7. The method of any of examples 4-6, wherein the first message includes a paging cycle configuration for the UE or a paging cycle configuration for the MBS session.
Example 8. The method of any of examples 1-7, wherein the message is a first message of one or more messages and the MBS session is a first MBS session of one or more MBS sessions, further comprising: determining to page the UE via the RAN for the one or more MBS sessions; and generating a message of the one or more messages including an identifier for each of the one or more MBS sessions and an identifier for the UE in response to the determining.
Example 9. A method for managing paging for multicast and broadcast services (MBS), the method implemented in a radio access network (RAN) and comprising: receiving, by processing hardware and from a core network (CN), an identifier for an MBS session and an indication to configure resources for the MBS session; transmitting, by the processing hardware to a user equipment (UE), a paging message including the identifier for the MBS session, when one or more radio connections between the UE and the RAN are inactive; and subsequently to the transmitting, broadcasting, by the processing hardware to the UE in accordance with one or more MBS resource configurations, one or more MBS data packets.
Example 10. The method of example 9, further comprising: broadcasting the one or more MBS resource configurations to the UE using the identifier for the MBS session; wherein broadcasting the one or more MBS data packets is subsequent to broadcasting the one or more MBS resource configurations.
Example 11. The method of example 9, wherein the UE is a first UE of a plurality of UEs, the paging message is a first paging message of one or more paging messages, and the transmitting further includes: transmitting, using an identifier for the first UE, the first paging message of the one or more paging messages to the first UE, the first paging message including the identifier for the MBS session; and transmitting, using an identifier for a second UE of the plurality of UEs, a second paging message of the one or more paging messages to the second UE, the second paging message including the identifier for the MBS session.
Example 12. The method of any of examples 9-11, wherein transmitting the paging message is in accordance with at least one of: a paging cycle configuration of the MBS session or at least one paging cycle configuration of the UE.
Example 13. The method of any of examples 9-11, wherein the UE is a first UE of a plurality of UEs, the paging message is a first paging message of one or more paging messages, and further comprising: transmitting a first subset of the one or more paging messages to some of the plurality of UEs in accordance with a paging cycle of the MBS session; and transmitting a second subset of the one or more paging messages to some of the plurality of UEs in accordance with at least one paging cycle configuration of the plurality of UEs.
Example 14. The method of any of examples 9-13, wherein the UE is a first UE of a plurality of UEs and the paging message is a first paging message of one or more paging messages, further comprising: in response to transmitting a paging message of the one or more paging messages, performing a state transition procedure with at least one UE of the plurality of UEs; and during the state transition procedure, facilitating the at least one UE joining the MBS session.
Example 15. An apparatus comprising processing hardware and configured to implement a method according to any of examples 1-14.
Example 16. The method of example 11, further comprising: receiving an identifier message from the CN, the identifier message including the identifier for the first UE and the identifier for the second UE.
Example 17. The method of example 11, further comprising: receiving a first identifier message from the CN, the first identifier message including the identifier for the first UE; and receiving a second identifier message from the CN, the second identifier message including the identifier for the second UE.
Example 18. The method of example 9, wherein the UE is a first UE of a plurality of UEs, the paging message is a first paging message of one or more paging messages, and the transmitting the first paging message includes: transmitting the first paging message of the one or more paging messages to the first UE in accordance with a paging cycle of the first UE; the method further comprising transmitting a second paging message of the one or more paging messages to a second UE in accordance with a paging cycle of the second UE.
Example 19. The method of any of examples 9-13, further comprising: receiving, from the CN, a message including at least the identifier for the MBS session and one or more parameters for paging; and generating the one or more MBS resource configurations based on at least the parameters for paging.
Example 20. The method of example 1, wherein the UE is a first UE of a plurality of UEs and the paging message is a first paging message of one or more paging messages, further comprising: identifying a number of UEs of the plurality of UEs to join the MBS session; and generating a number of messages equal to the number of UEs, wherein each message of the number of messages includes the identifier for the MBS session and an identifier for a corresponding UE of the number of UEs.
Example 21. The method of example 20, wherein each message of the number of messages further includes a paging cycle configuration for the corresponding UE of the number of UEs.
Example 22. The method of example 1, wherein the message including the identifier for the MBS session is a first message, the method further comprising: determining to page for a service; and determining whether to transmit, to the RAN, a second message including a UE identifier for the UE based on whether the service is an MBS.
Example 23. The method of example 22, wherein the first message further includes an MBS paging cycle configuration.
Example 24. The method of example 22 or 23, wherein the second message includes a UE paging cycle configuration for the UE.
Example 25. The method of example 1, wherein the message is a first message of one or more messages, further comprising: including the identifier for the MBS session in a UE ID field of the first message when the CN determines to transmit the first message for an MBS session.
Example 26. The method of example 25, wherein the first message further includes an indication that the UE ID field includes the identifier for the MBS session.
Example 27. The method of example 1, wherein the message is a first message of one or more messages and the MBS session is a first MBS session of one or more MBS sessions, further comprising: determining to page the UE via the RAN for the one or more MBS sessions; and generating a message of the one or more messages including an identifier for each of the one or more MBS sessions and without including an identifier for the UE in response to the determining.
Example 28. An apparatus comprising processing hardware and configured to implement a method according to any of examples 16-27.

The following additional considerations apply to the foregoing discussion.

In some implementations, the UE can receive data of an MBS in a broadcast session without performing a session join procedure for receiving the MBS. That is, the UE does not need to perform a session join procedure for a broadcast session. In other implementations, the UE can receive data of an MBS in a broadcast session in accordance with configuration parameters broadcast by the RAN, i.e., without performing a RRC reconfiguration procedure to receive configuration parameters to receive data of the MBS.

In some implementations, the UE has to perform a session join procedure to receive data of an MBS in a multicast session. In other implementations, the UE can only receive data of an MBS in a multicast session in accordance with configuration parameters received in a RRC reconfiguration message.

In some implementations, “MBS” can be replaced by “MBS session” or vice versa. In some implementations, “message” is used and can be replaced by “information element (IE)”. In some implementations, “IE” is used and can be replaced by “field”. In some implementations, “configuration” can be replaced by “configurations” or the configuration parameters. In some implementations, the “MBS session ID” can be replaced by the “MBS session IDs” and the “MBS session” can be replaced by “MBS sessions”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for managing paging for multicast and broadcast services (MBS), the method implemented in a core network (CN) and comprising:
receiving, at the CN and from an MBS network, an identifier for an MBS session;
transmitting, from the CN to a radio access network (RAN), a message including the identifier for the MBS session;
transmitting, from the CN to the RAN, one or more multicast configuration parameters associated with the MBS session; and
transmitting, from the CN to the RAN, one or more MBS data packets to be broadcast to a user equipment (UE) in accordance with the one or more multicast configuration parameters.

2. The method of claim 1, wherein the UE is a first one of a plurality of UEs, the method further comprising:
identifying a set of UEs of the plurality of UEs to join the MBS session; and
generating a message of the one or more messages including the identifier for the MBS session and an identifier for each UE of the set of UEs.

3. The method of claim 2, wherein the message further includes a paging cycle configuration for each of at least some of the set of UEs or a paging cycle configuration for the MBS session.

4. The method of claim 1, wherein the message is an MBS message of one or more messages, further comprising:
determining to transmit a first message of the one or more messages to the RAN; and
determining whether to transmit the MBS message as the first message or to transmit a UE message including an identifier for the UE as the first message based on whether the CN determines to transmit the first message for an MBS session.

5. The method of claim 1, wherein the UE is a first one of a plurality of UEs and the message is an MBS message of one or more messages, further comprising:
determining to page the plurality of UEs for an MBS session; and
determining whether to generate the MBS message or a plurality of UE messages, each UE message of the plurality of UE messages including an identifier for a different UE of the plurality of UEs, based on whether a base station of the RAN supports paging for MBS.

6. The method of claim 1, wherein the message is an MBS message of a plurality of messages, further comprising:
determining to transmit a first message to the RAN to page the UE; and
determining whether to transmit the MBS message as the first message based on whether the RAN pages the UE for an MBS session.

7. The method of claim 4, wherein the first message includes a paging cycle configuration for the UE or a paging cycle configuration for the MBS session.

8. The method of claim 1, wherein the message is a first message of one or more messages and the MBS session is a first MBS session of one or more MBS sessions, further comprising:
determining to page the UE via the RAN for the one or more MBS sessions; and
generating a message of the one or more messages including an identifier for each of the one or more MBS sessions and an identifier for the UE in response to the determining.

9. A method for managing paging for multicast and broadcast services (MBS), the method implemented in a radio access network (RAN) and comprising:
receiving, at the RAN and from a core network (CN), an identifier for an MBS session and an indication to page a user equipment (UE) participating in the MBS session;
transmitting, from the RAN to the UE, a paging message including the identifier for the MBS session, when one or more radio connections between the UE and the RAN are inactive;
receiving, at the RAN and from the CN, one or more parameters associated with the MBS session; and
subsequently to the transmitting, broadcasting, from the RAN to the UE in accordance with the one or more parameters, one or more MBS data packets.

10. The method of claim 9, further comprising:
broadcasting an MBS resource configuration to the UE using the identifier for the MBS session;
wherein broadcasting the one or more MBS data packets is subsequent to broadcasting the MBS resource configuration.

11. The method of claim 9, wherein the UE is a first UE of a plurality of UEs, the paging message is a first paging message of one or more paging messages, and the transmitting further includes:
transmitting, using an identifier for the first UE, the first paging message of the one or more paging messages to the first UE, the first paging message including the identifier for the MBS session; and
transmitting, using an identifier for a second UE of the plurality of UEs, a second paging message of the one or more paging messages to the second UE, the second paging message including the identifier for the MBS session.

12. The method of claim 9, wherein transmitting the paging message is in accordance with at least one of: a paging cycle configuration of the MBS session or at least one paging cycle configuration of the UE.

13. The method of claim 9, wherein the UE is a first UE of a plurality of UEs, the paging message is a first paging message of one or more paging messages, and further comprising:
transmitting a first subset of the one or more paging messages to some of the plurality of UEs in accordance with a paging cycle of the MBS session; and
transmitting a second subset of the one or more paging messages to some of the plurality of UEs in accordance with at least one paging cycle configuration of the plurality of UEs.

14. The method of claim 9, wherein the UE is a first UE of a plurality of UEs and the paging message is a first paging message of one or more paging messages, further comprising:
in response to transmitting a paging message of the one or more paging messages, performing a state transition procedure with at least one UE of the plurality of UEs; and
during the state transition procedure, facilitating the at least one UE joining the MBS session.

15. An apparatus, operating as a core network (CN) and configured for managing paging for multicast and broadcast services (MBS), the apparatus comprising:
processing hardware configured to:
receive, at the CN and from an MBS network, an identifier for an MBS session;
transmit, from the CN to a radio access network (RAN), a message including the identifier for the MBS session;
transmit, from the CN to the RAN, one or more multicast configuration parameters associated with the MBS session; and
transmit, from the CN to the RAN, one or more MBS data packets to be broadcast to a user equipment (UE) in accordance with the one or more multicast configuration parameters.

16. The apparatus of claim 15, wherein the UE is a first one of a plurality of UEs, and the processing hardware is further configured to:
identify a set of UEs of the plurality of UEs to join the MBS session; and
generate a message of the one or more messages including the identifier for the MBS session and an identifier for each UE of the set of UEs.

17. The apparatus of claim 16, wherein the message further includes a paging cycle configuration for each of at least some of the set of UEs or a paging cycle configuration for the MBS session.

18. The apparatus of claim 15, wherein the message is an MBS message of one or more messages, and the processing hardware is further configured to:
determine to transmit a first message of the one or more messages to the RAN; and
determine whether to transmit the MBS message as the first message or to transmit a UE message including an identifier for the UE as the first message based on whether the CN determines to transmit the first message for an MBS session.

19. The apparatus of claim 15, wherein the UE is a first one of a plurality of UEs and the message is an MBS message of one or more messages, and the processing hardware is further configured to:
determine to page the plurality of UEs for an MBS session; and
determine whether to generate the MBS message or a plurality of UE messages, each UE message of the plurality of UE messages including an identifier for a different UE of the plurality of UEs, based on whether a base station of the RAN supports paging for MBS.

20. The apparatus of claim 15, wherein the message is an MBS message of a plurality of messages, and the processing hardware is further configured to:
determine to transmit a first message to the RAN to page the UE; and
determine whether to transmit the MBS message as the first message based on whether the RAN pages the UE for an MBS session.
